(19) United States
(12) Patent Application Publication
(10) Pub. No.: US 2017/0326946 A1
(43) Pub. Date: Nov. 16, 2017

(54) Solar Powered Vehicle Fan Device

(71) Applicant: Yaakov Jacob, Lakewood, NJ (US)

(72) Inventor: Yaakov Jacob, Lakewood, NJ (US)

(21) Appl. No.: 15/587,268

(22) Filed: May 4, 2017

Related U.S. Application Data
(60) Provisional application No. 62/331,744, filed on May 4, 2016.

(51) Int. Cl. B60H 1/00; B60H 1/26

(52) U.S. Cl. CPC B60H 1/00828; B60H 1/262; B60H 1/00428; B60H 1/00778

(57) ABSTRACT

A vehicle fan device for maintaining a desired temperature of an interior compartment of a vehicle when the vehicle is parked is provided. The vehicle has a roof, a hood, and a trunk. The vehicle fan device comprises at least one solar panel mounted on the vehicle with the at least one solar panel collecting sunlight and converting sun energy into direct electrical current (DC). A battery stores the direct electrical current. A fan is electrically connected to the battery with the fan drawing air into or expelling air from within the interior of the vehicle. A switch mechanism activates the fan. The activated fan cools or warms the interior of the parked vehicle.

### CLAIM OF PRIORITY

This patent application claims priority under 35 USC 119 (e) (1) from U.S. Provisional Patent Application Ser. No. 62/331,744 filed May 4, 2016, of common inventorship herewith entitled, “Solar Powered Vehicle Fan and Associated Use Thereof,” which is incorporated herein by reference as though the same were set forth in its entirety.

### FIELD OF THE INVENTION

The present invention pertains to the field of vehicle accessories, and more specifically to the field of solar-powered heating and cooling fans designed to keep a vehicle's interior comfortably warm or cool (depending on the season) when the vehicle is parked and the engine is off or on.

### BACKGROUND OF THE INVENTION

One problem that is shared by literally hundreds of millions of consumers who own and operate motor vehicles: the problem that occurs when vehicles are parked and left with the windows up, in hot weather. The interiors of vehicles can become so hot as to be lethal, as well known from the news stories every summer, toddlers dying when their parents leave them in a locked car. Tragic as such stories are, they are thankfully, relatively rare, but the daily experience of getting into a stifling car, so hot that the steering wheel and the seat-belt buckle nearly burn one's hands, is an experience that virtually every motorist has had. With all the advanced technology that motor vehicles offer today, there ought to be a way to cool or, in cold weather, heat, a parked car's interior.

Accordingly, a need remains for solar powered vehicle fan in order to overcome at least one aforementioned shortcoming. The exemplary embodiment(s) satisfy such a need by providing a solar-powered heating and cooling fan that is convenient and easy to use, lightweight yet durable in design, versatile in its applications, and designed for keeping a vehicle's interior comfortably warm or cool (depending on the season) when the vehicle is parked and the engine is off or on.

### SUMMARY OF THE INVENTION

It is an object of the present invention to provide a solar-powered heating and cooling fan designed to keep a vehicle's interior comfortably warm or cool (depending on the season) when the vehicle is parked and the engine is off or on, in accordance with non-limiting exemplary embodiment(s) of the present disclosure.

The present invention is a vehicle fan device for maintaining a desired temperature of an interior compartment of a vehicle when the vehicle is parked. The vehicle has a roof, a hood, and a trunk. The vehicle fan device comprises at least one solar panel mounted on the vehicle with the at least one solar panel collecting sunlight and converting sun energy into direct electrical current (DC). A battery stores the direct electrical current. A fan is electrically connected to the battery with the fan drawing air into or expelling air from within the interior of the vehicle. A switch mechanism activates the fan. The activated fan cools or warms the interior of the parked vehicle.

In addition, the present invention includes a method for maintaining a desired temperature of an interior compartment of a vehicle when the vehicle is parked. The vehicle has a roof, a hood, and a trunk. The method comprises mounting at least one solar panel on the vehicle, collecting sunlight by the at least one solar panel, converting the sun energy into direct electrical current (DC), storing the direct electrical current in a battery, electrically connecting a fan to the battery, activating the fan by a switch mechanism, air into or expelling air from within the interior of the vehicle, and cooling or warming the interior of the parked vehicle.

The present invention further includes a vehicle fan device for maintaining a desired temperature of an interior compartment of a vehicle when the vehicle is parked. The vehicle has a roof, a hood, and a trunk. The vehicle fan device comprises at least one solar panel mounted on the vehicle with the at least one solar panel collecting sunlight and converting sun energy into direct electrical current (DC). A battery stores the direct electrical current. A fan is electrically connected to the battery with the fan drawing air into or expelling air from within the interior of the vehicle. A switch mechanism is mounted within the interior of the vehicle for activating the fan. An air conditioning system cools the air within the interior of the vehicle and a heating element heats the air within the interior of the vehicle. Upon a temperature within the interior of the vehicle ascending a first predetermined temperature, the air conditioning system is activated. Upon a temperature within the interior of the vehicle descending to a second predetermined temperature, the heating element is activated. The vehicle fan device cools or warms the interior of the parked vehicle.

Additionally, in an alternative embodiment, an opening between the passenger compartment and the trunk allows the egress of heated air into the trunk.

Additionally, in a further alternative embodiment, the solar panel can be situated in the car near the back window.

### BRIEF DESCRIPTION OF THE DRAWINGS

FIG. 1 is a perspective view illustrating a solar powered vehicle fan device, constructed in accordance with the present invention.

FIG. 2 is another perspective view illustrating the solar powered vehicle fan device, constructed in accordance with the present invention.

FIG. 3 is an elevational side view illustrating the solar powered vehicle fan device, constructed in accordance with the present invention, with the solar powered vehicle fan device mounted on a vehicle for cooling/heating the vehicle.

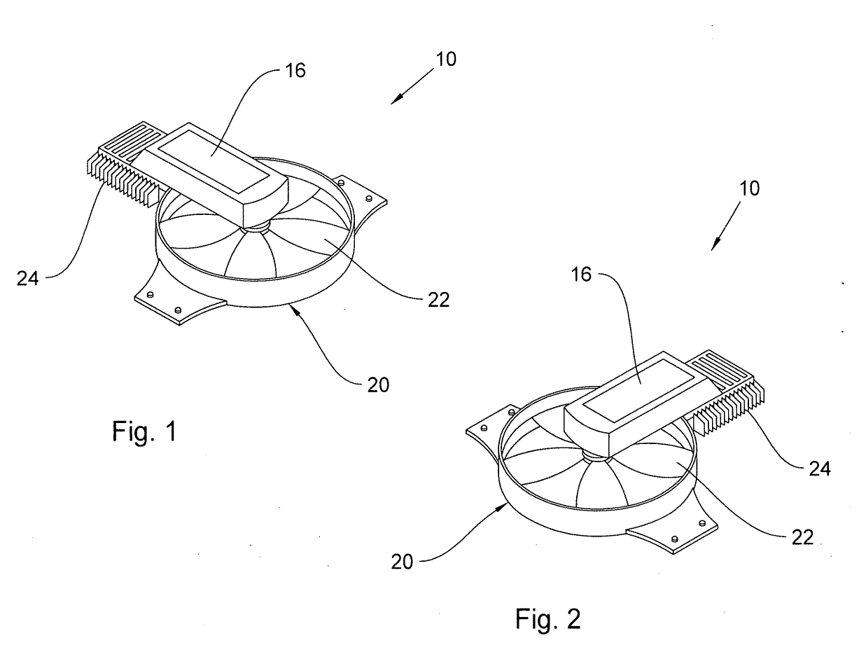

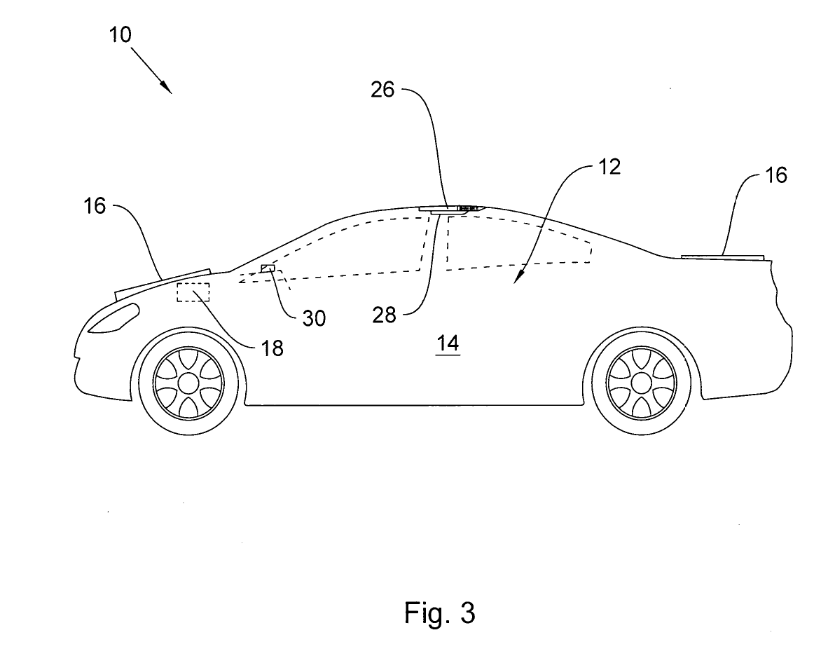

### DETAILED DESCRIPTION OF THE INVENTION

The present invention, hereinafter referred to as a Solar Powered Vehicle Fan Device, indicated generally at 10, is designed to keep an interior 12 of a vehicle 14 comfortably warm or cool (depending on the season) when the vehicle 14 is parked and the engine is off or on. It should be understood that the exemplary embodiment(s) may be used to cool/heat a variety of vehicles 14, and should not be limited to any particular vehicle described herein.

The Solar Powered Vehicle Fan Device 10 of the present invention includes at least one solar panel 16 mounted directly on the roof, hood, trunk, or dashboard of the vehicle 14. The Device 10 can be mounted onto any suitable surface of the vehicle, including but not limited to, roof, hood, trunk, dashboard, window, truckbed or any other suitable surface of the vehicle. The Solar Powered Vehicle Fan Device can include more than one solar panel 16 depending on the size and output of the solar panel(s) 16 used. The solar panels 16, also known as photo-voltaic cells, would function to collect sunlight and convert its energy into direct electrical current (DC) that is stored by a storage battery 18, as understood by those persons skilled in the art.

In addition, the Solar Powered Vehicle Fan Device 10 of the present invention includes a thermostat-activated interior fan-and-exhaust system 20 having an air-circulating fan 22 for removing overheated air from the interior 12 of the vehicle 14, providing for cooler, effective air-circulation within the vehicle 14. At least one air filter 24 can be provided to clean the air as the air enters the interior 12 of the vehicle 12. The fan-and-exhaust system 20 is preferably mounted to the roof of the vehicle 14 and electrically connected to the storage battery 18 charged by the solar panel 16 thereby providing power to the fan-and-exhaust system 20.

The fan-and-exhaust system 20 of the Solar Powered Vehicle Fan Device 10 of the present invention includes either an air conditioning system 26 to cool the interior 12 of the vehicle 14 or a heating element 28 to heat the interior 12 of the vehicle 14. The air conditioning system 26 uses chemicals that easily convert from a gas to a liquid and back again. The chemicals are used to transfer heat from the air inside of a vehicle 14 to the outside air. The air conditioning system 26 has three main parts: a compressor, a condenser and an evaporator. The heating element 28 converts electricity into heat through the process of resistive or Joule heating. Electric current passing through the element encounters resistance, resulting in heating of the heating element 28 independent of the direction of current flow. Both the air conditioning system 26 and the heating element 28 of the present invention are powered by the solar panels 16.

The fan 22 of the Solar Powered Vehicle Fan Device 10 can be driven by a DC motor and the DC motor (whether the vehicle's heater/air-conditioning fan or a separate fan) is powered by electricity from the storage battery 18 which can be either the vehicle's existing 12-volt battery or a separate storage battery 18. Preferably, the optimal design for the Solar Powered Vehicle Fan Device 10 uses the vehicle's existing fan and motor, and the vehicle's existing storage battery 18 which receives and stores direct current from the solar roof- or dashboard-mounted panels 16, and, when activated by a thermostatic switch 30, release current as needed to run the fan.

The Solar Powered Vehicle Fan Device 10 of the present invention additionally includes the thermostat-activated switch mechanism 30 located within the interior 12 of the vehicle 14, perhaps within the headliner. If the switch mechanism 30 is set at perhaps 80 degrees Fahrenheit, for instance, such that when the interior temperature exceeds 80 degrees, the thermostat will activate the air-circulating fan 22 of the fan-and-exhaust system 22. Or, either instead of or in addition to, the switch mechanism 30 can activate the fan 22 already in place for the vehicle's heat and air-conditioning systems, or could be a separate, dash-installed fan 22. As the fan 22 is intended to cool the interior 12 of the vehicle 14, it must function as an exhaust fan, expelling the heated air through a vent, and drawing in relatively cooler air through an intake vent. In cold weather, the Solar Powered Vehicle Fan Device 10 will also operate as a heating fan to keep the interior warm. In winter, the thermostat might be set at 60 degrees, so that if the interior temperature falls below this level, the fan's heater element 28 is activated.

The Solar Powered Vehicle Fan Device 10 of the present invention can be incorporated into the design and manufacture of new motor vehicles 14, and/or produced and sold as an add-on, aftermarket accessory thereby equipping cars, vans, SUVs, pickups, and larger trucks with an auxiliary heating system and cooling system, powered by the sun, and designed to keep the interior 12 of the vehicle 14 comfortably cool or warm (depending on the weather), when the vehicle 14 is parked (e.g., off or on). Relying on the sun for its operative energy, the Solar Powered Vehicle Fan Device 10, once installed, gives the motorist a cost-free means of keeping the interior of his or her vehicle 14, and any passengers or pets left waiting in the vehicle, comfortable and safe when the vehicle 14 is parked (e.g., off or on).

The Solar Powered Vehicle Fan Device 10 of the present invention automatically cools the interior 12 of a parked car, van, pickup, or SUV anytime the air inside the vehicle reaches a threshold temperature of 80 degrees Fahrenheit or any other desired temperature, saves motorists from the discomfort that they experience when getting into their vehicles 14 on a hot summer's day. And because the Solar Powered Vehicle Fan Device 10 operates as both a cooling and heating system, the vehicle owner is assured that any passengers, including children, or pets left waiting in the vehicle 14 are both comfortable and safe, whether the weather is hot or cold. The Solar Powered Vehicle Fan Device 10 achieves this by harnessing the power of the same sun that is making the inside of the vehicle so very hot to begin with by converting the energy of the beating sun into the electrical current that runs the Solar Powered Vehicle Fan Device 10.

The Solar Powered Vehicle Fan Device 10 of the present invention keeps a vehicle's interior tolerably cool (or warm) without draining the vehicle's battery, doing so at no cost, and automatically, for as long as necessary. Further, as an added benefit, the Solar Powered Vehicle Fan Device 10 also functions to recharge the vehicle's battery whenever the sun is out and the battery is not fully charged.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A vehicle fan device for maintaining a desired temperature of an interior compartment of a vehicle when the vehicle is parked, the vehicle having a roof, a hood, and a trunk, the vehicle fan device comprising:
at least one solar panel mounted on the vehicle, the at least one solar panel collecting sunlight and converting sun energy into direct electrical current (DC);
a battery for storing the direct electrical current;
a fan electrically connected to the battery, the fan drawing air into or expelling air from within the interior of the vehicle; and
a switch mechanism for activating the fan;
wherein the activated fan cools or warms the interior of the parked vehicle.

2. The vehicle fan device of claim 1 and further comprising:
an air conditioning system for cooling the air within the interior of the vehicle.

3. The vehicle fan device of claim 2 wherein upon a temperature within the interior of the vehicle reaching a first predetermined temperature, the air conditioning system is activated.

4. The vehicle fan device of claim 1 and further comprising:
a heating element for heating the air within the interior of the vehicle.

5. The vehicle fan device of claim 4 wherein upon a temperature within the interior of the vehicle reaching a second predetermined temperature, the heating element is activated.

6. The vehicle fan device of claim 1 wherein the battery is a vehicle's existing 12-volt battery.

7. The vehicle fan device of claim 1 wherein the battery is a battery separate from a vehicle's existing 12-volt battery.

8. The vehicle fan device of claim 1 wherein the fan is a vehicle's existing fan.

9. The vehicle fan device of claim 1 wherein the fan is separate from a vehicle's existing fan.

10. The vehicle fan device of claim 1 wherein the fan is driven by a DC motor powered by electricity from the storage battery.

11. The vehicle fan device of claim 1 wherein the switch mechanism is a manual switch.

12. The vehicle fan device of claim 1 wherein the switch mechanism automatically activates the fan upon the vehicle being in a parked condition.

13. The vehicle fan device of claim 1 wherein the switch mechanism automatically activates the fan upon the vehicle being in a parked condition.

14. A method for maintaining a desired temperature of an interior compartment of a vehicle when the vehicle is parked, the vehicle having a roof, a hood, and a trunk, the method comprising:
mounting at least one solar panel on the vehicle;
collecting sunlight by the at least one solar panel;
converting the sun energy into direct electrical current (DC);
storing the direct electrical current in a battery;
electrically connecting a fan to the battery;
activating the fan by a switch mechanism;
air into or expelling air from within the interior of the vehicle; and
cooling or warming the interior of the parked vehicle.

15. A vehicle fan device for maintaining a desired temperature of an interior compartment of a vehicle when the vehicle is parked, the vehicle having a roof, a hood, and a trunk, the vehicle fan device comprising:
at least one solar panel mounted on the vehicle, the at least one solar panel collecting sunlight and converting sun energy into direct electrical current (DC);
a battery for storing the direct electrical current;
a fan electrically connected to the battery, the fan drawing air into or expelling air from within the interior of the vehicle; and
a switch mechanism mounted within the interior of the vehicle for activating the fan;
an air conditioning system for cooling the air within the interior of the vehicle; and
a heating element for heating the air within the interior of the vehicle;
wherein upon a temperature within the interior of the vehicle ascending a first predetermined temperature, the air conditioning system is activated;
wherein upon a temperature within the interior of the vehicle descending to a second predetermined temperature, the heating element is activated; and
wherein the vehicle fan device cools or warms the interior of the parked vehicle.

16. The vehicle fan device of claim 15 wherein the battery is a vehicle's existing 12-volt battery.

17. The vehicle fan device of claim 15 wherein the battery is a battery separate from a vehicle's existing 12-volt battery.

18. The vehicle fan device of claim 15 wherein the fan is a vehicle's existing fan.

19. The vehicle fan device of claim 15 wherein the fan is separate from a vehicle's existing fan.

20. The vehicle fan device of claim 15 wherein the switch mechanism automatically activates upon the vehicle being in a parked condition and a temperature within the interior of the vehicle reaching either the first predetermined temperature or the second predetermined temperature.
